(19) United States
(12) Patent Application Publication
(10) Pub. No.: US 2019/0007142 A1
(43) Pub. Date: Jan. 3, 2019

(54) LIGHT IDENTIFICATION TRANSMISSION DEVICE AND LIGHT IDENTIFICATION COMMUNICATION SYSTEM

(71) Applicant: Panasonic Intellectual Property Management Co., Ltd., Osaka (JP)

(72) Inventors: Shojiro KIDO, Osaka (JP); Akihiro KISHIMOTO, Osaka (JP)

(21) Appl. No.: 16/010,441

(22) Filed: Jun. 16, 2018

(30) Foreign Application Priority Data
Jun. 29, 2017 (JP) 2017-127430

(51) Int. Cl. H04B 10/524; H04N 5/232; G08C 23/04; H04N 7/18; H04B 10/116; B60R 11/04; H04N 7/22; B60R 1/00

(52) U.S. Cl. CPC H04B 10/524; H04N 5/23203; G08C 23/04; H04N 7/185; B60R 2300/80; B60R 11/04; H04N 7/22; B60R 1/00; H04B 10/116

(57) ABSTRACT

A light identification (ID) transmission device includes: a light emitter that is elongated in a lateral direction and is configured to be attached to a first vehicle; and a light emission controller that divides a transmission target ID into packets of data, and causes the light emitter to emit modulated light that is modulated according to the packets.

### CROSS REFERENCE TO RELATED APPLICATION

This application claims the benefit of priority of Japanese Patent Application Number 2017-127430 filed on Jun. 29, 2017, the entire content of which is hereby incorporated by reference.

### BACKGROUND

### 1. Technical Field

The present disclosure relates to a light identification (ID) transmission device and a light ID communication system that transmit an ID of a vehicle using modulated light.

### 2. Description of the Related Art

A visible light communication technique is known which causes a light-emitting element such as a light-emitting diode (LED) to blink at high speed and recognizes, as data such as an ID, the blinking, by capturing the light-emitting element with a camera (an image sensor). Non Patent Literature (NPL) 1 (“Image Sensor-based Visible Light Communication Technology,” Panasonic Technical Journal Vol. 61 No. 2 November 2015, pp. 40-45, Nov. 16, 2015.) discloses a visible light communication technique using a line-scan mechanism of an image sensor. Moreover, Patent Literature (PTL) 1 (Japanese Unexamined Patent Application Publication No. 2015-225558) discloses a vehicle to vehicle communication system using a visible light communication technique.

### SUMMARY

In the visible light communication technique, allowing a receiving device such as a camera to receive data with improved accuracy is problematic.

The present disclosure provides a light ID transmission device and a light ID communication system that allow a receiving device to receive an ID with improved accuracy.

A light ID transmission device according to one aspect of the present disclosure includes: a light emitter that is elongated in a lateral direction and configured to be attached to a first vehicle; and a light emission controller that divides a transmission target ID into packets of data, and causes the light emitter to emit modulated light that is modulated according to the packets.

A light ID communication system according to one aspect of the present disclosure includes: a light emitter that is configured to be attached to a vehicle; a light emission controller that divides a transmission target ID into packets of data, and causes the light emitter to emit modulated light that is modulated according to the packets; and a camera that includes an image sensor and captures the light emitter with the image sensor. The light emitter is elongated along an extension direction of an exposure line of the image sensor.

A light ID transmission device and a light ID communication system according to the present disclosure allow a receiving device to receive an ID with improved accuracy.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a diagram for illustrating an outline of a light ID communication system according to an embodiment;

FIG. 2 is a diagram when a first vehicle to which a light emitter is attached is viewed from behind;

FIG. 3 is a block diagram illustrating a functional configuration of the light ID communication system according to the embodiment;

FIG. 4 is an operational sequence diagram of the light ID communication system according to the embodiment;

FIG. 5 is a diagram illustrating a first pattern of a non-light emission region produced in the light emitter;

FIG. 6 is a diagram illustrating a second pattern of the non-light emission region produced in the light emitter;

FIG. 7 is a diagram illustrating a specific configuration of the light emitter;

FIG. 8 is a diagram illustrating another specific configuration of the light emitter;

FIG. 9 is a diagram for illustrating a method of dividing a first ID into packets and transmitting the packets;

FIG. 10 is a schematic diagram illustrating luminance of modulated light;

FIG. 11 is a diagram illustrating the light emitter attached to a lateral face of a vehicle; and

FIG. 12 is a diagram illustrating the light emitter attached to the top face of a vehicle.

### DETAILED DESCRIPTION OF THE EMBODIMENT(S)

Hereinafter, an embodiment will be described with reference to the drawings. It should be noted that the following embodiment shows a general or specific example. The numerical values, shapes, materials, structural elements, the arrangement and connection of the structural elements, steps, the processing order of the steps, etc. described in the following embodiment are mere examples, and are therefore not intended to limit the scope of the present disclosure. Furthermore, among the structural elements in the following embodiment, those not recited in any one of the independent claims defining the most generic concepts are described as optional structural elements.

It should be noted that the figures are schematic diagrams and are not necessarily precise illustrations. Furthermore, in the figures, substantially identical structural elements are assigned the same reference signs, and overlapping descriptions may be omitted or simplified.

### Embodiment

### [Outline of Light ID Communication System]

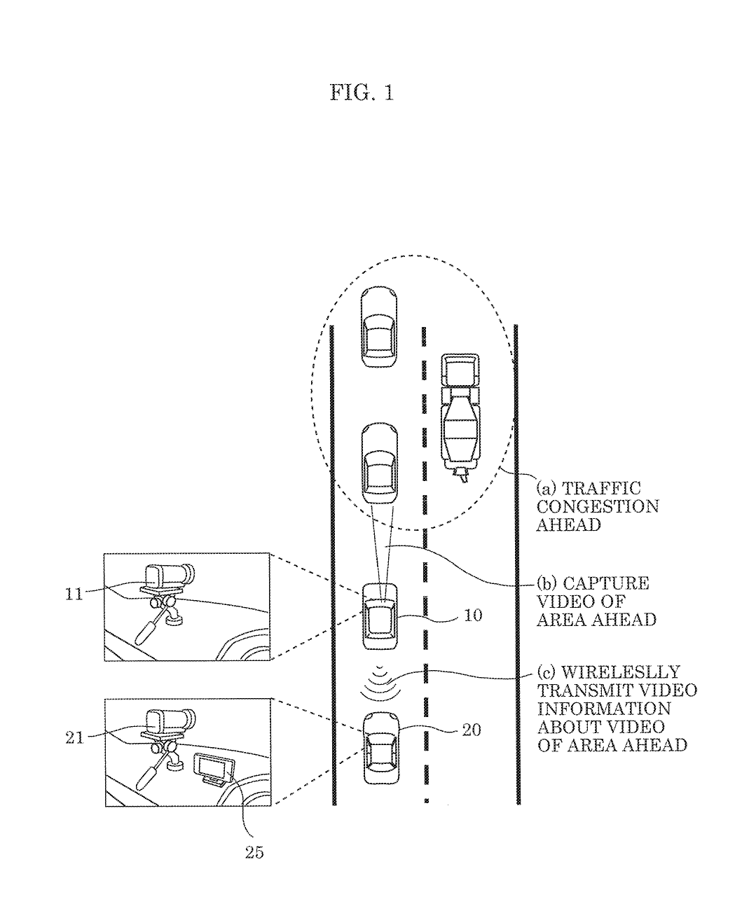

First, the following describes an outline of a light ID communication system according to an embodiment. FIG. 1 is a diagram for illustrating the outline of the light ID communication system according to the embodiment. Specifically, FIG. 1 is a diagram when first vehicle 10 and second vehicle 20 that travel on a road are viewed from top.

As shown in FIG. 1, it is assumed that a traffic congestion is caused while first vehicle 10 travels ahead of second vehicle 20 ((a) in FIG. 1). In such a case, when first camera 11 attached to first vehicle 10 captures a video of an area ahead of first vehicle 10 ((b) in FIG. 1), and the video is displayed on display 25 in second vehicle 20, the driver of second vehicle 20 can check a situation ahead of first vehicle 10.

In particular, if first vehicle 10 is a heavy vehicle such a bus or a truck, the driver of second vehicle 20 cannot see the area ahead of first vehicle 10. In that case, the driver of second vehicle 20 is likely to be irritated because the driver of second vehicle 20 does not know why first vehicle 10 travels slowly.

In contrast, if the driver of second vehicle 20 can check the situation ahead of first vehicle 10, the driver of second vehicle 20 finds that the traffic congestion slows down first vehicle 10, and thus can stay calm to drive. In other words, when the video captured by first camera 11 attached to first vehicle 10 is displayed on display 25 in second vehicle 20 behind first vehicle 10, the comfort of the driver of second vehicle 20 is increased.

Here, in order to display the video captured by first camera 11 attached to first vehicle 10 on display 25 in second vehicle 20, it is necessary to wirelessly transmit video information about the video from first vehicle 10 to second vehicle 20 ((c) in FIG. 1). In order for second vehicle 20 to request the video information from first vehicle 10, the ID (identification information) of first vehicle 10 must be specified in advance. However, first vehicle 10 is usually a vehicle that second vehicle 20 encounters while traveling, and thus second vehicle 20 has difficulty identifying the ID of first vehicle 10 in advance.

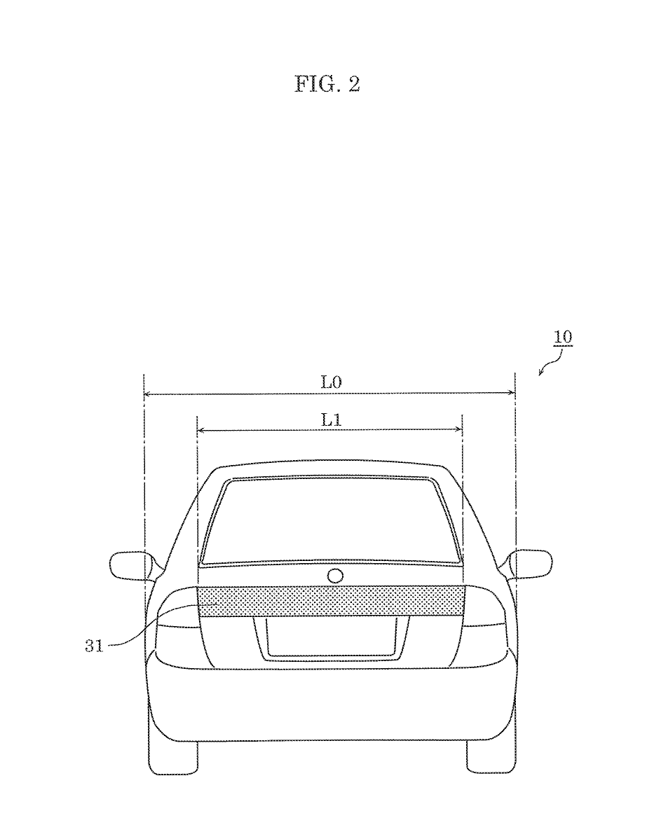

In view of this, in the light ID communication system according to the embodiment, as shown in FIG. 2, light emitter 31 is attached to the rear face of first vehicle 10. FIG. 2 is a diagram when first vehicle 10 to which light emitter 31 is attached is viewed from behind.

Light emitter 31 is a device for exclusive use in optical communication that is different from the brake lamps and tail lamps of first vehicle 10. In the light ID communication system according to the embodiment, light emitter 31 always emits modulated light that is modulated according to the ID of first vehicle 10. Second vehicle 20 is capable of identifying the ID of first vehicle 10 by causing second camera 21 attached to second vehicle 20 to capture light emitter 31.

### [Configuration of Light ID Communication System]

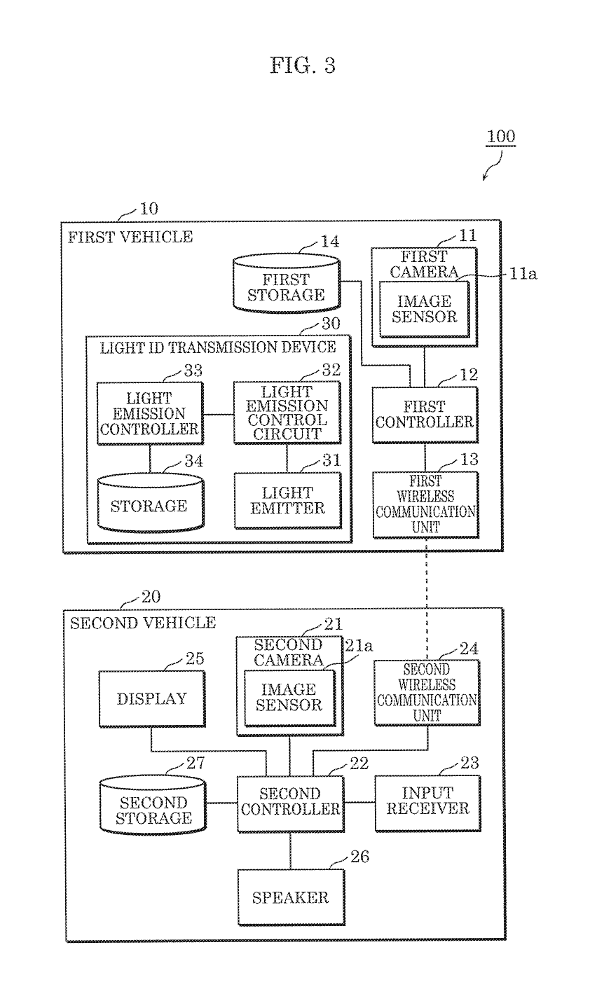

Next, the following describes a specific configuration of the light ID communication system according to the embodiment. FIG. 3 is a block diagram illustrating a functional configuration of the light ID communication system according to the embodiment.

As shown in FIG. 3, light ID communication system 100 according to the embodiment includes, as structural elements attached to first vehicle 10, light ID transmission device 30, first camera 11, first controller 12, first wireless communication unit 13, and first storage 14. Moreover, light ID communication system 100 includes, as structural elements attached to second vehicle 20, second camera 21, second controller 22, input receiver 23, second wireless communication unit 24, display 25, speaker 26, and second storage 27.

### [Light ID Transmission Device]

First, the following describes a configuration of light ID transmission device 30 attached to first vehicle 10. Light ID transmission device 30 is a device that transmits the ID of first vehicle 10 to a vehicle located behind first vehicle 10 (e.g., second vehicle 20), by blinking light. Specifically, light ID transmission device 30 includes light emitter 31, light emission control circuit 32, light emission controller 32, and storage 34.

As shown in FIG. 2, light emitter 31 is a light-emitting device that is elongated in a lateral direction and configured to be attached to the rear face of first vehicle 10. Light emitter 31 emits modulated light that is modulated according to the ID of first vehicle 10. Modulated light is, for example, visible light, but may be invisible light such as infrared light as long as the invisible light can be captured by second camera 21.

Light emitter 31 is an elongated, panel-shaped light-emitting device that is implemented by, for example, a chip-on-board (COB) light-emitting module in which LED chips are longitudinally disposed on an elongated substrate or a cover that covers a light-emitting module. Light emitter 31 may be implemented by a surface-mount device (SMD) light-emitting module in which SMD LED elements are longitudinally disposed on a substrate. It should be noted that solid-state light-emitting elements other than LEDs (LED elements), such as semiconductor lasers or inorganic electroluminescent (EL) elements, may be used for light emitter 31.

Light emission control circuit 32 is a circuit that converts electrical power supplied from a power source in first vehicle 10 into DC power suitable for light emission of light emitter 31, and outputs the DC power. Light emission control circuit 32 includes, for example, a constant current circuit that supplies constant current to light emitter 31, and a modulation circuit that modules current supplied from the constant current circuit. The modulation circuit includes a switching element for modulating current to be supplied to light emitter 31.

Light emission controller 33 controls the light emission of light emitter 31 by regulating electrical power to be supplied from light emission control circuit 32 to light emitter 31. For example, light emission controller 33 reads the ID of first vehicle 10 stored in storage 34, and performs switching control (on and off) of the switching element included in the modulation circuit of light emission control circuit 32, according to the read ID. Accordingly, since current to be supplied from light emission control circuit 32 to light emitter 31 is modulated, light emission controller 33 allows light emitter 31 to emit modulated light that is modulated according to the ID of first vehicle 10. The modulated light blinks at a speed (e.g., several kHz to several MHz) imperceptible to the human eye. Second camera 21 is capable of recognizing, as the ID of first vehicle 10, the modulated light (blinking of light emitter 31) using image sensor 21a.

Storage 34 is a storage device that stores the ID of first vehicle 10, a control program executed by light emission controller 33, etc. Specifically, storage 34 is implemented by a semiconductor memory etc. It should be noted that in the embodiment, the ID of first vehicle 10 means a communication ID for wireless communication between first vehicle 10 and second vehicle 20 that is performed using radio waves, and is not limited to an ID associated with first vehicle 10. For example, the ID of first vehicle 10 may be an ID associated with first wireless communication unit 13.

### [Other Structural Elements Attached to First Vehicle]

Next, the following describes structural elements that are attached to first vehicle 10 other than light ID transmission device 30.

First camera 11 includes image sensor 11a, and captures a video of an area ahead of first vehicle 10 on the basis of control by first controller 12. Image sensor 11a is, for example, a complementary metal-oxide-semiconductor (CMOS) image sensor. Image sensor 11a may also be a charge-coupled device (CCD) image sensor etc. Image sensor 11a is an image sensor using rolling shutter, but may be an image sensor using global shutter.

First controller 12 is a control device that controls first camera 11 and first wireless communication unit 13. For example, when first wireless communication unit 13 receives a request for a video captured by first camera 11, first controller 12 causes first camera 11 to capture a video of an area ahead of first vehicle 10, and first wireless communication unit 13 to wirelessly transmit video information (a video signal) about the captured video. First controller 12 causes first wireless communication unit 13 to wirelessly transmit alarm information indicating that a traffic congestion is ahead of first vehicle 10.

First controller 12 is implemented by a processor, a microcomputer, or a dedicated communication circuit etc. In accordance with an alternate embodiment, first controller 12 may be implemented by a combination of at least two of the processor, the microcomputer, and the dedicated communication circuit.

First wireless communication unit 13 is a wireless module (a wireless communication device) for use in wireless communication between first vehicle 10 and second vehicle 20 that is performed using radio waves. It should be noted that radio waves do not include visible light and infrared light.

For example, first wireless communication unit 13 receives a request for a video captured by first camera 11, from second wireless communication unit 24 attached to second vehicle 20. Moreover, first wireless communication unit 13 wirelessly transmits video information about the video captured by first camera 11, to second wireless communication unit 24, on the basis of control by first controller 12. Furthermore, first wireless communication unit 13 wirelessly transmits alarm information on the basis of control by first controller 12.

Although examples of a wireless communication standard (protocol) used by first wireless communication unit 13 include ZigBee (registered trademark), Bluetooth (registered trademark), and a wireless local area network (LAN), the wireless communication standard is not particularly limited. Moreover, a radio wave frequency band for use in the wireless communication is not particularly limited.

First storage 14 is a storage device that stores the ID of first vehicle 10, video information about a video captured by first camera 11, vehicle information about first vehicle 10 (information indicating the manufacturer of first vehicle 10, model information about first vehicle 10, body color information about first vehicle 10, etc.), a control program executed by first controller 12, etc. Specifically, first storage 14 is implemented by a semiconductor memory etc.

It should be noted that part or all of first camera 11, first controller 12, first wireless communication unit 13, and first storage 14 may be structural elements included in light ID transmission device 30.

### [Structural Elements Attached to Second Vehicle]

Next, the following describes structural elements attached to second vehicle 20.

Second camera 21 includes image sensor 21a and captures a video of an area ahead of second vehicle 20 and including light emitter 31, on the basis of control by second controller 22. Image sensor 21a is, for example, a CMOS image sensor. Image sensor 21a is, for example, an image sensor using rolling shutter.

Second controller 22 is a control device that controls second camera 21, second wireless communication unit 24, display 25, and speaker 26. For example, when input receiver 23 receives an input for instructing acquisition of a video from first vehicle 10, second controller 22 causes second wireless communication unit 24 to wirelessly transmit a request for the video. Moreover, when second wireless communication unit 24 receives video information, second controller 22 causes display 25 to display the video using the received video information. When second wireless communication unit 24 receives alarm information, second controller 22 causes speaker 26 to output sound using the received alarm information.

Second controller 22 is implemented by a processor, a microcomputer, or a dedicated communication circuit etc. In the alternative embodiment, second controller 22 may be implemented by a combination of at least two of the processor, the microcomputer, and the dedicated communication circuit.

Input receiver 23 is a user interface that receives an input from a user. For example, input receiver 23 receives, from the user, an input for instructing acquisition of a video from first vehicle 10. Specifically, input receiver 23 is a touch panel disposed opposite to a display screen of display 25, but may be a hardware key (a button).

Second wireless communication unit 24 is a wireless module (a wireless communication device) for use in wireless communication between first vehicle 10 and second vehicle 20 that is performed using radio waves. For example, second wireless communication unit 24 wirelessly transmits a request for a video captured by first camera 11 to first wireless communication unit 13 on the basis of control by second controller 22. Moreover, second wireless communication unit 24 receives, from first wireless communication unit 13, video information about the video captured by first camera 11. Furthermore, second wireless communication unit 24 receives alarm information from first wireless communication unit 13.

Like first wireless communication unit 13, a wireless communication standard (protocol) used by second wireless communication unit 24 and a radio wave frequency band for use in the wireless communication are not particularly limited.

Display 25 displays a video using video information received by second wireless communication unit 24. Display 25 is controlled by second controller 22. Display 25 includes, as a display device, a liquid crystal panel or an organic EL panel etc.

Speaker 26 outputs sound using alarm information received by second wireless communication unit 24. Examples of the outputted sound include a message notifying that a traffic congestion is ahead.

Second storage 27 is a storage device that stores the ID of second vehicle 20, video information about a video captured by second camera 21, vehicle information about second vehicle 20 (information indicating the manufacturer of second vehicle 20, model information about second vehicle 20, body color information about second vehicle 20, etc.), a control program executed by second controller 22, etc. Specifically, second storage 27 is implemented by a semiconductor memory etc. It should be noted that in the embodiment, the ID of second vehicle 20 means a communication ID for wireless communication between first vehicle 10 and second vehicle 20 that is performed using radio waves, and is not limited to an ID associated with second vehicle 20. For example, the ID of second vehicle 20 may be an ID associated with second wireless communication unit 24.

### [Operation of Light ID Communication System]

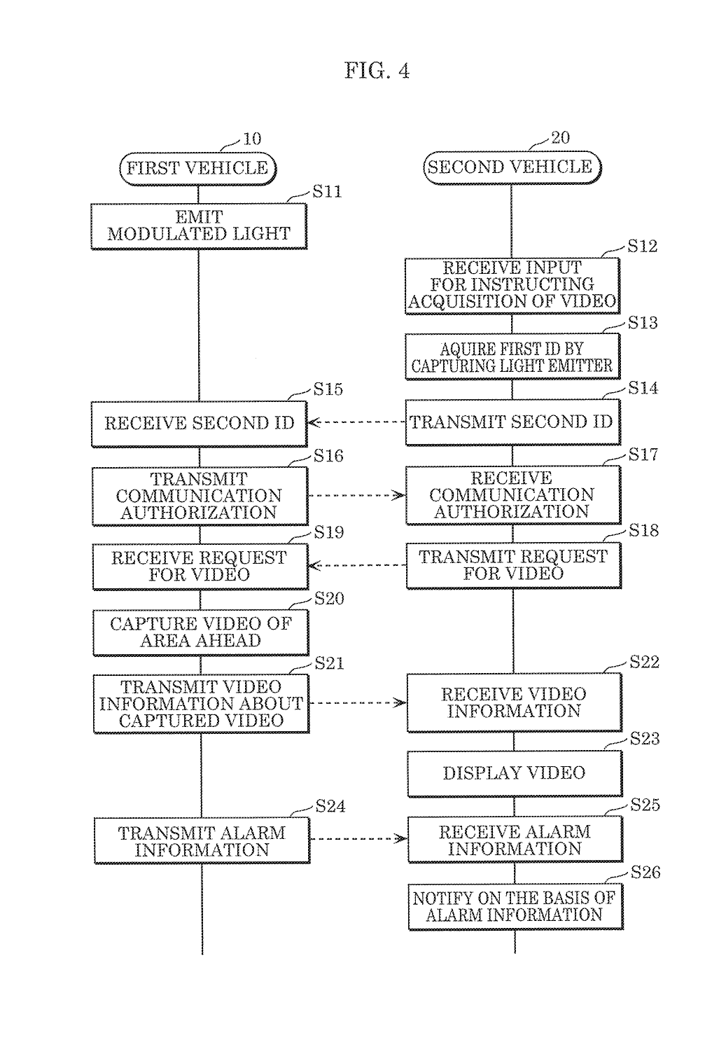

Next, the following describes the operation of light ID communication system 100. FIG. 4 is an operational sequence diagram of light ID communication system 100.

First, light emission controller 33 of light ID transmission device 30 causes light emitter 31 to emit modulated light that is modulated according to the ID of first vehicle 10 (transmission target ID) (S11). Specifically, light emission controller 33 reads the ID of first vehicle 10 (hereinafter also referred to as a first ID) stored in storage 34, and performs switching control (on and off) of the switching element included in the modulation circuit of light emission control circuit 32, according to the read first ID. It should be noted that as described later, light emission controller 33 may divide the first ID into packets and cause light emitter 31 to emit modulated light that is modulated according to the packets.

In the meanwhile, when first vehicle 10 located ahead of second vehicle 20 travels very slowly, the driver of second vehicle 20 inputs, to input receiver 23, an input for instructing acquisition of a video of an area ahead of first vehicle 10. When input receiver 23 receives this input (S12), second controller 22 causes second camera 21 to capture light emitter 31 attached to the rear face of first vehicle 10. Second controller 22 identifies, through image processing, a region blinking at high speed in the video captured by second camera 21, that is, a region in which light emitter 31 appears, and acquires the first ID by reading the blinking of the identified region (S13).

Next, second controller 22 causes second wireless communication unit 24 to wirelessly transmit a communication authorization request in which the acquired first ID is specified as a destination (S14). The communication authorization request includes the ID of second vehicle 20 (hereinafter also referred to as a second ID).

When first wireless communication unit 13 receives the communication authorization request (S15), first controller 12 stores, as a communication authorization ID, the second ID included in the received communication authorization request into first storage 14. Subsequently, first controller 12 causes first wireless communication unit 13 to wirelessly transmit a communication authorization (S16).

When second wireless communication unit 24 receives the communication authorization (S17), second controller 22 causes second wireless communication unit 24 to wirelessly transmit a request for a video in which the first ID is specified as a destination (S18). Specifically, the request for the video is a request for the video captured by first camera 11. As above, second wireless communication unit 24 wirelessly transmits the request for the video captured by first camera 11, on the basis of the first ID acquired by second camera 21 capturing light emitter 31. It should be noted that the request for the video includes the second ID.

When first wireless communication unit 13 receives the request for the video (S19), first controller 12 checks whether the second ID included in the received request for the video is stored as the communication authorization ID in first storage 14. Subsequently, first controller 12 causes first camera 11 to capture a video of an area ahead of first vehicle 10 (S20), and second wireless communication unit 24 to wirelessly transmit video information about the captured video (S21). At this time, first controller 12 may transmit vehicle information about first vehicle 10 stored in first storage 14, in addition to the video information.

It should be noted that first camera 11 need not capture a video in response to a request for a video. For example, first camera 11 may always capture a video. In this case, since video information about the captured video is always accumulated in first storage 14, step S20 is omitted. In step S21, first controller 12 reads video information about a recent video accumulated in first storage 14, and causes second wireless communication unit 24 to wirelessly transmit the read video information.

When second wireless communication unit 24 receives the video information (S22), second controller 22 causes display 25 to display the video using the received video information (S23). In other words, display 25 displays the video using the received video information.

As a result, the driver of second vehicle 20 can check a situation ahead of first vehicle 10. For example, if the driver of second vehicle 20 finds that a traffic congestion slows down first vehicle 10, the driver of second vehicle 20 can respond such as keeping a distance between the cars by slowly decreasing the speed.

Here, in the case where the vehicle information about first vehicle 10 is received in addition to the video information in step S22, second controller 22 may cause speaker 26 to output sound notifying the manufacturer, model, body color, etc. of first vehicle 10, using the received vehicle information.

Consequently, the driver of second vehicle 20 can check whether the displayed video was captured by first camera 11 of first vehicle 10 in front. First vehicle 10 located ahead of second vehicle 20 is often replaced by another vehicle while second vehicle 20 travels, and it is useful to notify the driver of second vehicle 20 of what kind of a vehicle captured a displayed video. For example, when the driver of second vehicle 20 determines that the displayed video is not a video from a vehicle presently located ahead of second vehicle 20, the driver of second vehicle 20 can perform the acquisition of a video again. Specifically, the driver of second vehicle 20 may perform step S12 again.

After step S23, when first controller 12 determines that a traffic disruption such as a traffic congestion is ahead of first vehicle 10 while providing the video to second vehicle 20, first controller 12 causes first wireless communication unit 13 to wirelessly transmit alarm information (S24). The determination on whether the traffic congestion is ahead of first vehicle 10 is made by comparing (matching), for example, a traffic congestion video pattern stored in first storage 14 in advance with a video being currently captured.

When second wireless communication unit 24 receives the alarm information (S25), second controller 22 causes speaker 26 to output sound notifying the traffic congestion, using the received alarm information.

In consequence, the driver of second vehicle 20 finds that the traffic congestion slows down first vehicle 10. This allows the driver of second vehicle 20 to respond such as keeping a distance between the cars by slowly decreasing the speed.

### [Shape of Light Emitter]

As shown in FIG. 1, light emitter 31 is elongated in the lateral direction. The following describes an effect produced by such light emitter 31. Image sensor 21a included in second camera 21 uses the rolling shutter. In the rolling shutter, a video is captured for each exposure line.

NPL 1 discloses a line scan sampling method as a method for receiving an ID with an image sensor using rolling shutter. When the number of pixels (the number of exposure lines) of image sensor 21a in the vertical direction is 1080 and a frame rate is 30 fps, according to the line scan sampling method disclosed in NPL 1, modulated light emitted by light emitter 31 can be sampled 32400 (=1080×30) times per second at high speed.

An extension direction of the exposure lines is usually parallel to the lateral direction of an object to be captured by second camera 21. Accordingly, if light emitter 31 to be captured by second camera 21 is elongated in the lateral direction, it is possible to increase the accuracy of receiving the first ID. For example, a configuration that causes two brake lamps attached to the rear face of first vehicle 10 to emit modulated light is likely to reduce the accuracy of receiving the first ID because the two brake lamps are disposed apart from each other. In contrast, if light emitter 31 is elongated in the lateral direction, it is possible to increase the accuracy of receiving the first ID.

It should be noted that the inventors found that it is desirable that to achieve satisfactory reception accuracy, at least one-fourth of total width L1 (shown in FIG. 2) of light emitter 31 in the lateral direction be within the capturing range of second camera 21 (image sensor 21a). On the other hand, it is desirable that to identify the rear face of first vehicle 10 through image recognition processing, at least one-half of total width L0 of the rear face of first vehicle 10 be within the capturing range of second camera 21. In the case of a capturing condition in which one-half of total width L0 of the rear face of first vehicle 10 is within the capturing range of second camera 21, L1>L0×½ may be satisfied in order to make at least one-fourth of total width L1 of light emitter 31 in the lateral direction be within the capturing range of second camera 21. In other words, length L1 of light emitter 31 in the lateral direction may be greater than the half of length L0 of the rear face of first vehicle 10 in the lateral direction.

It should be noted that when a distance between first vehicle 10 and second vehicle 20 is huge, second camera 21 may use an optical zoom or the above-described line scan sampling method may be applied to only a specific portion of the capturing range of second camera 21 in which light emitter 31 appears. With this, it is possible to increase the accuracy of receiving the first ID.

### [Specific Configuration of Light Emitter]

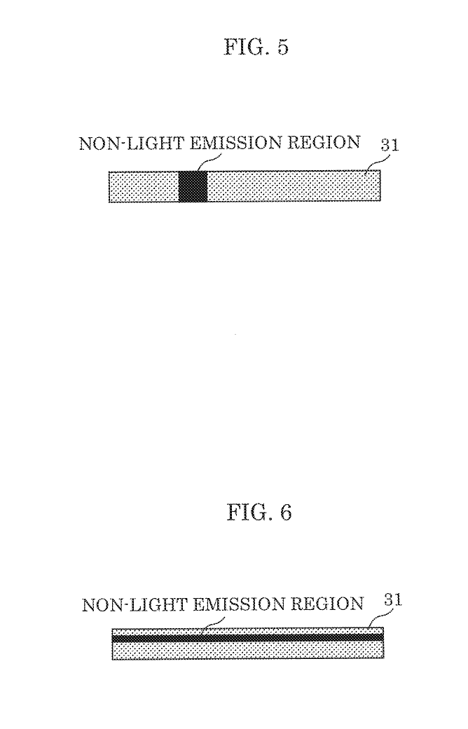

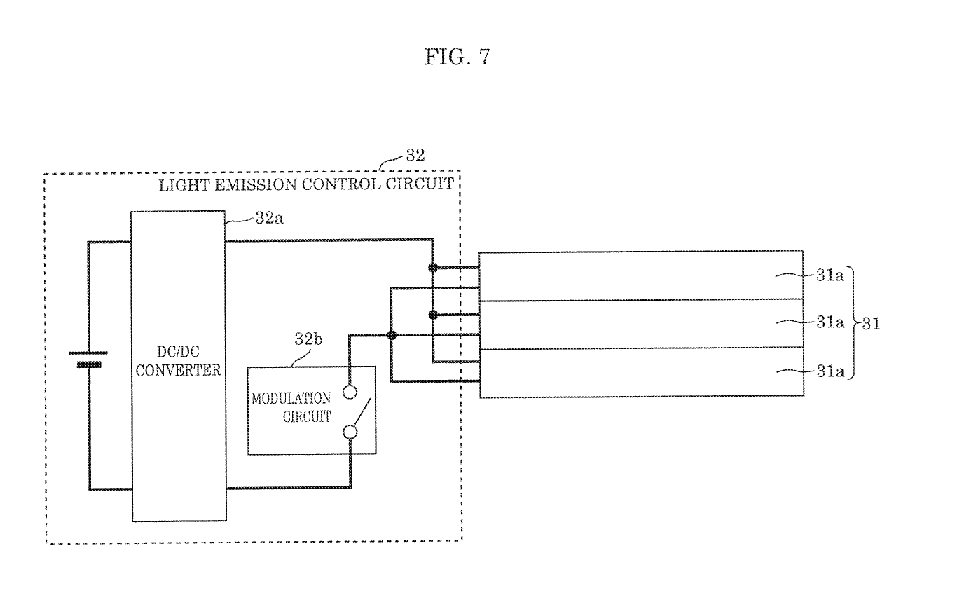

When a non-light emission region is produced in light emitter 31 due to a breakdown etc., the accuracy of receiving the first ID is reduced. FIG. 5 and FIG. 6 each are a diagram illustrating a pattern of the non-light emission region produced in light emitter 31. In each of FIG. 5 and FIG. 6, the black portion indicates the non-light emission region.

As shown in FIG. 5, when the non-light emission region in a first pattern is produced that extends from an end to another end of light emitter 31 in a vertical direction, an adverse effect is caused over exposure lines. In other words, the accuracy of receiving the first ID is reduced significantly. In contrast, the non-light emission region in a second pattern that extends from an end to another end of light emitter 31 in the lateral direction inhibits the reduction of the accuracy of receiving the first ID in comparison to the non-light emission region in the first pattern shown in FIG. 5.

In view of this, the following describes the specific configuration of light emitter 31 that reduces the production of the non-light emission region in the first pattern as shown in FIG. 5. FIG. 7 is a diagram illustrating the specific configuration of light emitter 31.

As shown in FIG. 7, light emitter 31 may include light sources 31a that are elongated in the lateral direction. Each of light sources 31a is, for example, an organic EL element, and performs surface emission. It should be noted that each light source 31a may be a light source that is elongated in the lateral direction, and may be implemented by a light-emitting element other than the organic EL element. Light sources 31a are arranged side by side in the vertical direction. Light sources 31a are disposed, for example, next to each other.

Light emission control circuit 32 supplies electrical power to light sources 31a in parallel. Light emission control circuit 32 includes DC/DC converter 32a and modulation circuit 32b.

In such light emitter 31, the non-light emission region in the first pattern is not produced even if one of light sources 31a is broken down. Accordingly, it is possible to inhibit the reduction of the accuracy of receiving the first ID when one light source 31a is broken down.

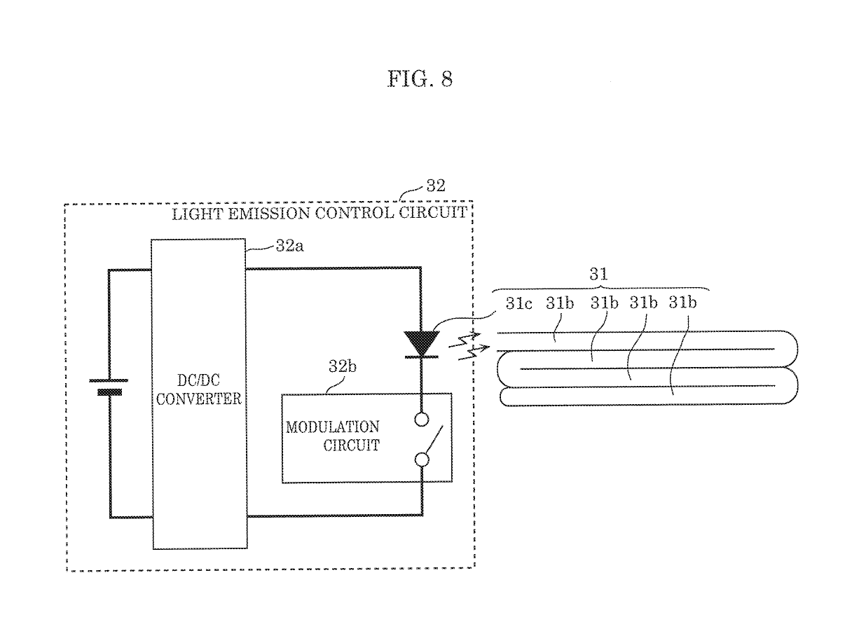

FIG. 8 is a diagram illustrating another specific configuration of light emitter 31. As shown in FIG. 8, light emitter 31 may include light guides 31b that are elongated in the lateral direction and tube-shaped, and light source 31c.

Light guides 31b are, for example, luminous fibers, but may be other light guiding tubes. Light source 31c is implemented by, for example, a light-emitting element such as an LED. For example, light emission control circuit 32 including DC/DC converter 32a and modulation circuit 32b supplies electrical power to light source 31c.

Light guides 31b are arranged side by side in the vertical direction and are communicated by connecting end portions of light guides 31b to each other, and light emitted by light source 31c is introduced to the inside of light guides 31b.

Such light emitter 31 is not likely to produce the non-light emission region in the first pattern. Accordingly, it is possible to inhibit the reduction of the accuracy of receiving the first ID when light source 31c is broken down. Moreover, since entire light emitter 31 stops emitting light when light source 31c is broken down, such light emitter 31 facilitates the detection of a breakdown.

### [Division and Transmission of First ID]

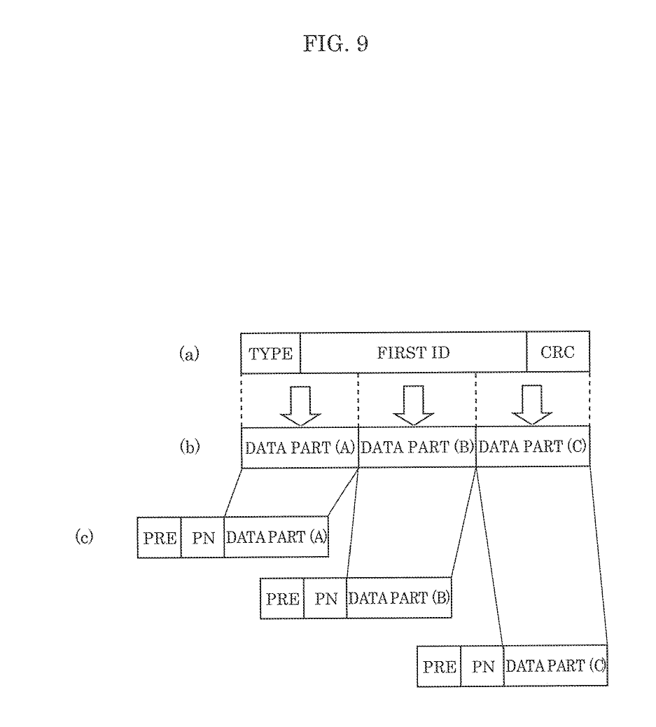

Light emission controller 33 may divide the first ID into packets and cause light emitter 31 to emit modulated light that is modulated according to the packets. FIG. 9 is a diagram for illustrating a method of dividing the first ID into packets and transmitting the packets.

As shown in (a) of FIG. 9, light emission controller 33 generates transmission data of the first ID, a transmission target, by adding information indicating a transmission protocol (TYPE) to the start of the first ID, and information for error detection (CRC) to the end of the first ID.

Next, as shown in (b) of FIG. 9, light emission controller 33 divides the generated transmission data. Although light emission controller 33 divides the transmission data into three parts, that is, part A, part B, and part C in FIG. 9, the number of parts into which the transmission data is divided is not particularly limited.

Next, as shown in (c) of FIG. 9, light emission controller 33 assigns a preamble (PRE) and a packet number (PN) to each of the three parts of the divided transmission data. As a result, each of the three parts of the divided transmission data is packetized. It should be noted that although the preamble is assigned to the start of each of the three parts of the divided transmission data in the example of FIG. 9, the preamble may be assigned to the end of the same instead of the start or may be assigned to both the start and end of the same.

Finally, light emission controller 33 causes light emitter 31 to emit modulated light that is modulated according to the packetized parts of the transmission data. In other words, light emission controller 33 divides the first ID into the packets and causes light emitter 31 to emit the modulated light that is modulated according to the packets.

When the first ID is divided into the packets and the packets are transmitted, even if second camera 21 (image sensor 21a) fails to receive (read) part of the first ID, second controller 22 is capable of restoring (acquiring) the first ID by the packets being repeatedly transmitted using modulated light. For example, even if part C out of part A, part B, and part C is not successfully received during the first transmission of the first ID with the modulated light, as long as part C is received during the second or subsequent transmission, second controller 22 is capable of restoring (acquiring) the first ID. In other words, it is possible to increase the reception accuracy.

More specifically, light emitter 31 may transmit at least two parts of packetized transmission data (packets constituting the first ID) during a period corresponding to one frame of a video captured by second camera 21 (image sensor 21a), by emitting modulated light.

With this, even if a non-light emission region is partially produced in light emitter 31, it is possible to increase the chance that second camera 21 receives at least one packet during a period corresponding to one frame.

### [Short-Pulse Driving]

Light emitter 31 is a communication-dedicated, light-emitting device different from the brake lamps and tail lamps. For this reason, there is a less need for light emitter 31 to have a function of illuminating a surrounding area, and as long as second camera 21 is capable of recognizing blinking of light emitter 31, there is no particular problem with light emitter 31 being dark to a human.

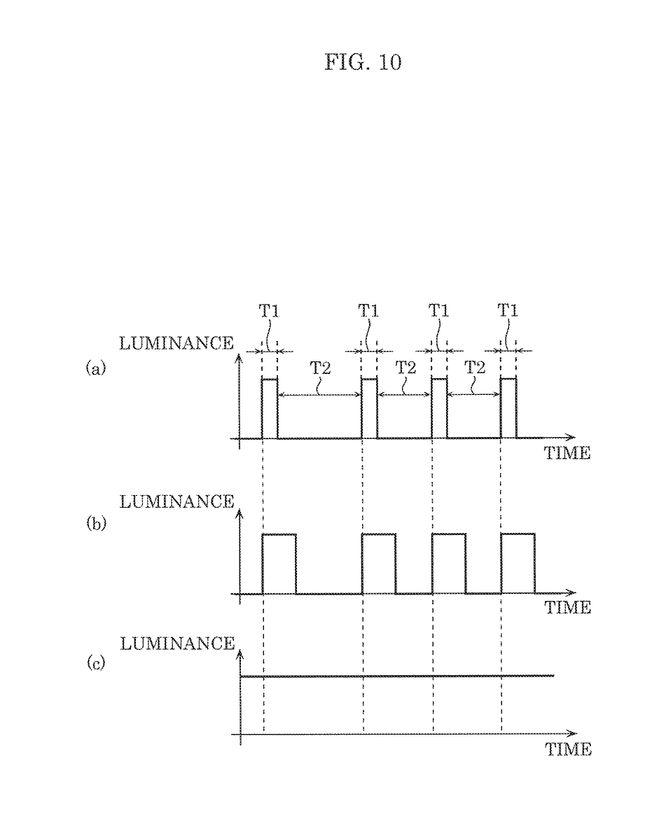

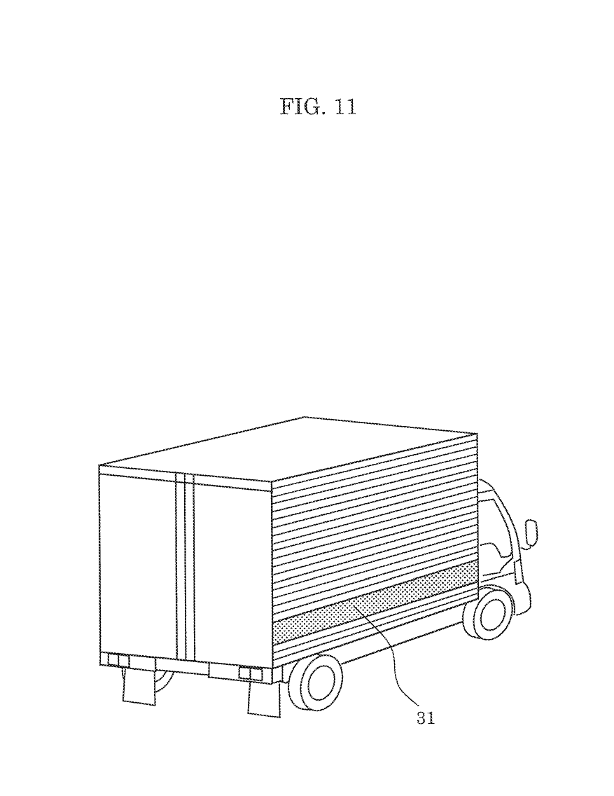

In view of the above, for example, when modulated light emitted by light emitter 31 is based on a modulation mode such as pulse-position modulation (PPM), the modulated light may be light that is short-pulse (instantaneous-pulse) modulated according to packets. Accordingly, the modulated light is achieved that has high instantaneous luminance but has average luminance that is reduced. In other words, the modulated light is achieved that is less noticeable to the human eye and is recognizable to second camera 21 (image sensor 21a). FIG. 10 is a schematic diagram illustrating luminance of modulated light.

As shown in (a) of FIG. 10, the modulated light repeats a bright state and a dark state (blinks). It should be noted that the dark state includes both an off state and a state in which the modulated light is emitted dimly.

Light emission controller 33 controls light emitter 31 such that the sum of periods T1 in which the modulated light is in the bright state and which are included in a predetermined period is smaller than the sum of periods T2 in which the modulated light is in the dark state and which are included in the predetermined period. In other words, light emission controller 33 performs short-pulse driving of light emitter 31 such that periods T1 in which the modulated light is in the bright state are shorter on average than periods T2 in which the modulated light is in the dark state. For example, light emission controller 33 controls light emitter 31 such that a percentage (duty cycle) of periods of the bright state to the predetermined period is less than 20%. Moreover, the instantaneous luminance is, for example, at least five times higher than the average luminance.

As described above, the modulated light alternately repeats a state of first luminance and a state of second luminance higher than the first luminance. If the length of a period in which the modulated light has the first luminance is less than the length of a period in which the modulated light has the second luminance, it is possible to reduce power consumption necessary for transmitting the first ID.

It should be noted that when light emitter 31 emits white light using a combination of a blue LED and a phosphor, the frequency of modulated light (the frequency of drive current for emitting modulated light) is, for example, at least 1 kHz and at most 2 MHz. Here, 1 kHz, the lower limit, is a value determined to reduce a flicker perceived by a human, and 2 MHz, the upper limit, is a value determined on the basis of a response speed of the phosphor.

It should be noted that when a pulse width is set to before or after an exposure time (e.g., 100 μsec) of image sensor 21a, it is possible to increase the accuracy of receiving the first ID by second camera 21.

On the other hand, in order for the user to visually check an abnormality of light emitter 31, light emitter 31 may emit light brightly for a certain period. In view of this, light emission controller 33 may perform, in addition to normal control for causing light emitter 31 to emit the modulated light as shown in (a) of FIG. 10, maintenance control for causing light emitter 31 to emit light that is higher in luminance than the modulated light emitted in the normal control. The normal control is an example of first control, and the maintenance control is an example of second control.

The maintenance control is, for example, control used for breakdown detection or vehicle inspection. The normal control and the maintenance control are selectively performed on the basis of, for example, an input of the user received by an input receiver (not shown) included in light ID transmission device 30.

In the maintenance control, as shown in (b) of FIG. 10, light emitter 31 emits the modulated light, but a period in which the modulated light is in the bright state is longer than that in the normal control. It should be noted that as shown in (c) of FIG. 10, in the maintenance control, light emitter 31 may stop emitting the modulated light, and emit light having certain luminance.

Such maintenance control facilitates the detection of a non-light emission region by the user.

### [Location of Light Emitter]

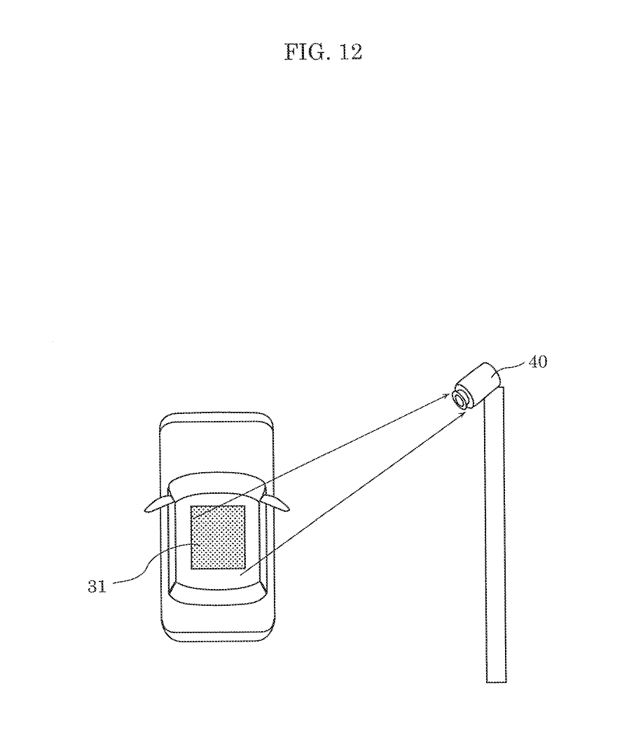

Although light emitter 31 is attached to the rear face of first vehicle 10 in the aforementioned embodiment, light emitter 31 may be attached to a portion of a vehicle other than the rear face of the vehicle. For example, light emitter 31 may be attached to a lateral face of the vehicle or the top face of the vehicle. FIG. 11 is a diagram illustrating light emitter 31 attached to a lateral face of a vehicle (a truck). FIG. 12 is a diagram illustrating light emitter 31 attached to the top face of a vehicle. Moreover, though not shown, if short-pulse driving of light emitter 31 is performed, light emitter 31 may be attached to the front face of a vehicle (e.g., in the vicinity of the headlamps). This is because, when short-pulse driving of light emitter 31 is performed, light emitter 31 does not interfere with (dazzle) oncoming drivers.

It should be noted that the lateral direction of light emitter 31 means a lateral direction seen from a light ID receiving device. Accordingly, it can be said that light emitter 31 shown in FIG. 11 and light emitter 31 shown in FIG. 12 are both light emitters that are elongated in the lateral direction.

Moreover, in the aforementioned embodiment, the example is described in which the light ID is transmitted and received between the vehicles. In other words, light ID transmission device 30 and the receiving device (second camera 21) are attached to the respective vehicles. As shown in an example of FIG. 12, however, the receiving device may be monitoring camera 40 disposed at a high place. In other words, the receiving device need not be attached to the vehicle.

### [Advantageous Effects Etc.]

As described above, light ID transmission device 30 includes: light emitter 31 that is elongated in a lateral direction and configured to be attached to first vehicle 10; and light emission controller 33 that divides a first ID into packets of data, and causes light emitter 31 to emit modulated light that is modulated according to the packets.

With this, it is possible to increase the accuracy of receiving the first ID by second camera 21.

Moreover, the modulated light may be light that is short-pulse modulated according to the packets.

With this, it is possible to reduce power consumption necessary for transmitting the first ID.

Moreover, light emitter 31 may be configured to be attached to a rear face of first vehicle 10.

With this, light ID transmission device 30 is capable of transmitting an ID to a vehicle behind first vehicle 10, by emitting the modulated light.

Moreover, as shown in FIG. 2, length L1 of light emitter 31 in the lateral direction may be greater than a half of length L0 of the rear face of first vehicle 10 in the lateral direction.

With this, it is possible to increase the accuracy of receiving the first ID by second camera 21.

Moreover, as shown in FIG. 7, light emitter 31 may include light sources 31a that are elongated in the lateral direction, and light sources 31a may be arranged side by side in a vertical direction.

In such light emitter 31, a non-light emission region over exposure lines is not produced even if one of light sources 31a is broken down. Accordingly, it is possible to inhibit the reduction of the accuracy of receiving the first ID when one light source 31a is broken down.

Moreover, as shown in FIG. 8, light emitter 31 may include: light guides 31b that are elongated in the lateral direction and are tube-shaped; and light source 31c. Light guides 31b may be arranged side by side in a vertical direction and be communicated by connecting end portions of light guides 31b to each other, and light emitted by light emitter 31 may be introduced to the inside of light guides 31b.

In such light emitter 31, a non-light emission region over exposure lines is not likely to be produced. Accordingly, it is possible to inhibit the reduction of the accuracy of receiving the first ID.

Moreover, light emission controller 33 may selectively perform normal control for causing light emitter 31 to emit the modulated light, and maintenance control for causing light emitter 31 to emit light that is higher in luminance than the modulated light. The normal control is an example of first control, and the maintenance control is an example of second control.

Such maintenance control facilitates the detection of a non-light emission region by the user.

Moreover, light ID communication system 100 includes: light emitter 31 that is configured to be attached to first vehicle 10; light emission controller 33 that divides a transmission target ID into packets of data, and causes light emitter 31 to emit modulated light that is modulated according to the packets; and second camera 21 that includes image sensor 21a and captures light emitter 31 with image sensor 21a. Light emitter 31 is elongated along an extension direction of an exposure line of image sensor 21a.

With this, it is possible to increase the accuracy of receiving the first ID by second camera 21.

Moreover, second camera 21 may be configured to be attached to second vehicle 20 different from first vehicle 10. Light ID communication system 100 may further include: first camera 11 that is configured to be attached to first vehicle 10; and wireless communication unit 24 that is configured to be attached to second vehicle 20 and performs wireless communication using radio waves. Second wireless communication unit 24 may transmit a request for a video captured by first camera 11, on the basis of the ID acquired by second camera 21 capturing light emitter 31.

With this, second wireless communication unit 24 is capable of acquiring the video captured by first camera 11.

Moreover, first camera 11 may capture a video of an area ahead of first vehicle 10, and light emitter 31 may be configured to be attached to a rear face of first vehicle 10.

With this, light emitter 31 is capable of transmitting an ID to second vehicle 20 behind first vehicle 10, by emitting the modulated light. Second wireless communication unit 24 is capable of acquiring the video of the area ahead of first vehicle 10.

Moreover, light ID communication system 100 may further include: first wireless communication unit 13 that is configured to be attached to first vehicle 10 and performs wireless communication using radio waves; and display 25 that is configured to be attached to second vehicle 20. First wireless communication unit 13 may receive the request and transmit video information about the video captured by first camera 11, in response to the request received. Second wireless communication unit 24 may receive the video information transmitted. Display 25 may display the video on the basis of the video information.

With this, light ID communication system 100 is capable of displaying the video captured by first camera 11 attached to first vehicle 10, on display 25 in second vehicle 20.

Moreover, light emitter 31 may transmit at least two of the packets during a period corresponding to one frame of the video captured by second camera 21, by emitting the modulated light.

With this, it is possible to increase the possibility that second camera 21 transmits at least one packet during the period corresponding to the one frame.

### Other Embodiments

Although the embodiment is described above, the present disclosure is not limited to the embodiment.

For example, in the aforementioned embodiment, the processes executed by a particular processing unit may be executed by another processing unit. Moreover, the sequence in which processes are executed may be changed, and plural processes may be executed in parallel. Furthermore, the distribution of the structural elements included in the light ID communication system is a mere example. For example, all the structural elements attached to the first vehicle may be attached to a single device (the light ID transmission device) or may be distributed among devices. In addition, all the structural elements attached to the second vehicle may be attached to a single device or may be distributed among devices.

Moreover, in the aforementioned embodiment, each of the structural elements such as the first controller and the second controller may be implemented by dedicated hardware or through execution of a software program. Each structural element may also be implemented by reading and executing, by a program executing unit such as a CPU or a processor, a software program recorded on a recording medium such as a hard disk or a semiconductor memory.

Furthermore, each of the structural elements such as the first controller and the second controller may be a circuit (or an integrated circuit). These circuits may, as a whole, constitute a single circuit, or may each be an independent circuit. In addition, the circuits may each be a general-purpose processor or a dedicated circuit.

Moreover, general or specific aspects of the present disclosure may be realized as a system, device, method, integrated circuit, computer program, non-transitory computer-readable medium such as a CD-ROM, or any given combination thereof. For example, one aspect of the present disclosure may be realized as a method for transmitting an ID. In addition, one aspect of the present disclosure may be realized as a program causing a computer to execute the method for transmitting an ID or as a non-transitory recording medium onto which the program is recorded.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light identification (ID) transmission device, comprising:
a light emitter that is elongated in a lateral direction and is configured to be attached to a vehicle; and
a light emission controller that divides a transmission target ID into packets of data, and causes the light emitter to emit modulated light that is modulated according to the packets.

2. The light ID transmission device according to claim 1,
wherein the modulated light is light that is short-pulse modulated according to the packets.

3. The light ID transmission device according to claim 1,
wherein the light emitter is configured to be attached to a rear face of the vehicle.

4. The light ID transmission device according to claim 3,
wherein a length of the light emitter in the lateral direction is greater than a half of a length of the rear face of the vehicle in the lateral direction.

5. The light ID transmission device according to claim 1,
wherein the light emitter includes a plurality of light sources that are elongated in the lateral direction, and
the plurality of light sources are arranged side by side in a vertical direction.

6. The light ID transmission device according to claim 1,
wherein the light emitter includes: a plurality of light guides that are elongated in the lateral direction and are tube-shaped; and a light source, and
the plurality of light guides are arranged side by side in a vertical direction and are communicated by connecting end portions of the plurality of light guides to each other, and light emitted by the light emitter is introduced to inside of the plurality of light guides.

7. The light ID transmission device according to claim 1,
wherein the light emission controller selectively performs first control for causing the light emitter to emit the modulated light, and second control for causing the light emitter to emit light that is higher in luminance than the modulated light.

8. The light ID transmission device according to claim 1,
wherein the light emission controller divides the transmission target ID into at least a first packet, a second packet, and a third packet,
the first packet includes information indicating a transmission protocol, and a first portion of the transmission target ID,
the second packet includes a second portion of the transmission target ID, and
the third packet includes a third portion of the transmission target ID, and information for error detection.

9. The light ID transmission device according to claim 1,
wherein the light emitter is configured to be attached to a lateral face of the vehicle.

10. The light ID transmission device according to claim 1,
wherein the light emitter is configured to be attached to a top face of the vehicle.

11. A light identification (ID) communication system, comprising:
a light emitter that is configured to be attached to a vehicle;
a light emission controller that divides a transmission target ID into packets of data, and causes the light emitter to emit modulated light that is modulated according to the packets; and
a camera that includes an image sensor and captures the light emitter with the image sensor,
wherein the light emitter is elongated along an extension direction of an exposure line of the image sensor.

12. The light ID communication system according to claim 11,
wherein the vehicle is a first vehicle, and the camera is a second camera that is configured to be attached to a second vehicle different from a first vehicle,
the light ID communication system, further comprising:
a first camera that is configured to be attached to the first vehicle; and
a wireless communication circuit that is configured to be attached to the second vehicle and performs wireless communication using radio waves,
wherein the wireless communication circuit transmits a request for a video captured by the first camera, on the basis of the transmission target ID acquired by the second camera capturing the light emitter.

13. The light ID communication system according to claim 12,
wherein the first camera captures a video of an area ahead of the first vehicle, and
the light emitter is configured to be attached to a rear face of the first vehicle.

14. The light ID communication system according to claim 12, further comprising:
a first wireless communication circuit that is configured to be attached to the first vehicle and performs wireless communication using radio waves; and
a display that is configured to be attached to the second vehicle,
wherein the first wireless communication unit receives the request and transmits video information about the video captured by the first camera, in response to the request received,
a second wireless communication circuit, which is the wireless communication unit, receives the video information transmitted, and
the display displays the video on the basis of the video information.

15. The light ID communication system according to claim 11,
wherein the light emitter transmits at least two of the packets during a period corresponding to one frame of the video captured by the camera, by emitting the modulated light.

16. A method for communicating between a first vehicle and a second vehicle traveling behind the first vehicle, the first vehicle including a light emitter configured to be attached to a rear of the first vehicle and a first camera which acquires a video of traffic in front of the first vehicle, the second vehicle including a second camera, the method comprising:
using the second camera to acquire a transmission target identification (ID) from modulated light emitted by the light emitter;
in association with the transmission target ID acquired, transmitting a request from the second vehicle to the first vehicle for the video acquired by the first camera; and
transmitting the video acquired by the first camera from the first vehicle to the second vehicle in response to the request.

17. The method according to claim 16,
wherein the second camera includes an image sensor and the light emitter is elongated along an extension direction of an exposure line of the image sensor.

18. The method according to claim 16,
wherein a length of the light emitter in a lateral direction is greater than a half of a length of the rear face of the first vehicle in the lateral direction.

19. The method according to claim 16,
wherein the light emitter includes a plurality of light sources that are elongated in a lateral direction, and
the plurality of light sources are arranged side by side in a vertical direction.
